(19) United States
(12) Patent Application Publication
(10) Pub. No.: US 2025/0077941 A1
(43) Pub. Date: Mar. 6, 2025

(54) DATA AUGMENTATION EVALUATION AND AUTOMATED TRAINING SET IMPROVEMENT VIA TYPICALITY

(71) Applicant: Robert Bosch GmbH, Stuttgart (DE)

(72) Inventors: Chen QIU, Pittsburgh, PA (US); Sabrina SCHMEDDING, Tiefenbronn (DE); Bahare AZARI, San Jose, CA (US); Nikita TIKHONOV, Moscow (RU); Filipe CONDESSA, Pittsburgh, PA (US)

(21) Appl. No.: 18/241,450

(22) Filed: Sep. 1, 2023

(51) Int. Cl. G06N 20/00

(52) U.S. Cl. CPC G06N 20/00

(57) ABSTRACT

Disclosed embodiments include methods for evaluating augmented training elements. The augmented training elements may be generated using different augmentation techniques. Disclosed embodiments may generate training set useful for training a plurality of different machine-learning models.

### TECHNICAL FIELD

The present disclosure relates generally to the field of artificial intelligence. More specifically, disclosed embodiments relate to data augmentation methods useful for generating training sets for machine-learning models.

### BACKGROUND

Training and developing deep learning models frequently requires a large amount of diverse and informative training samples in training sets useful to train the deep learning models. However, collecting high-quality samples may be costly (e.g., in time, manpower, and/or computing power) in many applications, e.g., industrial inspection, automated optical inspection, medical imaging applications. In practice, data-intensive deep learning methods may suffer from the scarcity of data. For alleviating data scarcity, data augmentation techniques are sometimes used and have demonstrated effectiveness on a variety of tasks.

However, not all data augmentations are equally helpful. For example, a model trained on many strongly noised images may make biased predictions on real-world scenarios since the strongly noised images may be distinct from the real images (i.e., far away on typical deep learning embeddings). Previously, a large body of works did extensive empirical evaluations to find which data augmentation to use for which data domain on which task. The evaluation is usually done by comparing the performance of a specific model trained with various data augmentations.

### SUMMARY

Repeating the training for evaluating each data augmentation type is time-consuming and may waste computational resources. Additionally, the evaluation results may be biased toward the interested task. For example, image classification tasks and semantic segmentation tasks prefer different data augmentations. Consequently, there is a need in industry for efficient methods for evaluating data augmentations suitable for inclusion in a training set useful for training one or more machine-learning models.

Disclosed embodiments may differ from prior art solutions in at least two perspectives. First, disclosed embodiments may need only a single trained generative model for evaluating a plurality of data augmentations as opposed to prior art methods that require a different trained model for evaluation each different augmentation. Second, disclosed embodiments may use statistics estimated via a generative model rather than a model performance on a specific task.

Disclosed embodiments include methods comprising: estimating an empirical entropy of a training set on which a generative model has been trained; generating a typicality score for the distance between 1) an augmented training element of a training element included in the training set and 2) a typicality set of the trained generative model, wherein the typicality score is based on the estimated empirical entropy; and comparing the typicality score to a threshold to determine whether the augmented training element is suitable for inclusion into the training set. Other disclosed embodiments include non-transitory memory including processor-executable instructions that, when executed by one or more processors, causes a system to perform operations including: estimating an empirical entropy of a training set on which a generative model has been trained; generating a typicality score for the distance between 1) an augmented training element of a training element included in the training set and 2) a typicality set of the trained generative model, wherein the typicality score is based on the estimated empirical entropy; and comparing the typicality score to a threshold to determine whether the augmented training element is suitable for inclusion into the training set. Other disclosed embodiments include systems comprising: one or more processors; and non-transitory memory including processor-executable instructions that, when executed by the one or more processors, causes the system to perform operations including: estimating an empirical entropy of a training set on which a generative model has been trained; for each of a plurality of augmented training elements, generating a typicality score based on the estimated empirical entropy; for each of the plurality of augmented training elements, comparing the generated typicality score to a threshold to determine whether the augmented training element is suitable for inclusion into the training set; and including into the training set each of the plurality of augmented training elements that is determined to be suitable for inclusion into the training set.

### BRIEF DESCRIPTION OF THE DRAWINGS

FIG. 1 illustrates a flowchart of an example method in accordance with disclosed embodiments.

FIG. 2 illustrates a flowchart of an example method in accordance with disclosed embodiments.

FIG. 3 illustrates an example embodiment of a general computer system in accordance with the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Deep learning models have achieved remarkable results on various tasks, e.g., image classification, semantic segmentation, time series prediction. However, deep learning models are also data hungry, namely, these models rely on a sufficiently substantial number of diverse samples to have a well-generalized performance. Unfortunately, big data (and diverse data) is not always available in many application domains, such as medical image applications. One popular solution for alleviating the data scarcity is using data augmentations to enhance the size and quality of the training dataset. Many survey and benchmark papers have studied the effectiveness of data augmentations on various tasks and compared various data augmentations in terms of their resulting model performance via extensive empirical evaluations. The extensive empirical evaluations require a large amount of computation resources and intensive expert feedback. There is still a lack of an efficient way for evaluating data augmentations automatically.

Generative models are often trained to approximate the true distribution p*(x) of the training samples. The trained generative models offer an effective and efficient way to estimate the density p(x; θ) (with model parameters θ) of high-dimensional data, such as images.

One method for data augmentation evaluation is based on density estimation via generative models. It is expected that the model estimated density can reveal how close a sample is to the training data distribution p*(x). Namely, the trained model predicts high likelihood to the samples close to the training data distribution and lower likelihood to the samples that are far away from the training data distribution. However, this is not the case for density estimation in high dimension space. For example, a trained normalizing flow model predicts a higher likelihood to an all-black image (never observed during training) than to a training sample.

This is caused by an issue of density estimation in high dimension space. A typical set of a generative model contains a majority of the probability mass of a distribution but not necessarily the highest density or probability points. This issue is often referred to as Gaussian Anulus theorem, which stipulates that samples concentrate on the spherical shell of radius \sqrt{d} (typical set) in a d-dimension isotropic Gaussian distribution. So, although the origin has the highest density, it is far from the typical set where most samples are drawn from.

Disclosed embodiments may evaluate data augmentations by measuring if the augmented training samples are in or close to the typical set of a generative model trained on a training set. The typical set of a distribution is the set whose elements have an information content sufficiently close to that of the expected information of the distribution. The distance of a sample to the typical set may be denoted with a typicality score. The typicality score may be estimated by the distance of the log-density (log p(x; θ)) to the empirical entropy of a model as

$$T S ( x ) = \vert - log p ( x ; θ ) - {\hat{H}}_{p} \vert , \qquad ( 1 )$$

where TS(x) is the typicality score of sample x, p(x; θ) is the density of sample x with respect to a model having parameters θ, and Ĥₚ is the estimated empirical entropy, which may be computed over the training set as

$${\hat{H}}_{p} = {E}_{x ∼ {D}_{t r a i n}} [ - log p ( x ; θ ) ] , \qquad ( 2 )$$

where E is the expected value of the samples x taken from the training set Dₜᵣₐᵢₙ. When a sample has a low typicality score, it is close to the empirical entropy of the model. That is, the lower the typicality score the closer the sample is to the empirical entropy of the model. Typicality may be used to detect out-of-distribution samples. In some disclosed embodiments, out-of-distribution samples are considered unsuitable for inclusion in the training set. Disclosed embodiments may use typicality for data augmentation evaluation. In some disclosed embodiments, an augmented sample is considered suitable when its typicality score is less than or equal to a threshold α. The threshold α may be estimated from the training samples (with an optional tunable parameter ϵ to control the acceptable region) as

$$α = {max}_{x ∈ {D}_{t r a i n}} T S ( x ) + ϵ , \qquad ( 3 )$$

where ϵ may have a default value of zero. By tuning or adjusting ϵ, the user can adjust the tolerance region to the typicality score based on their applications.

Disclosed embodiments leverage a typicality score to evaluate data augmentations. Data augmentations that are determined to be suitable for training a machine-learning model may be included in a training set useful for training the machine-learning. Data augmentations that are determined to not be suitable for training a machine-learning model may be excluded from a training set useful for training the machine-learning model.

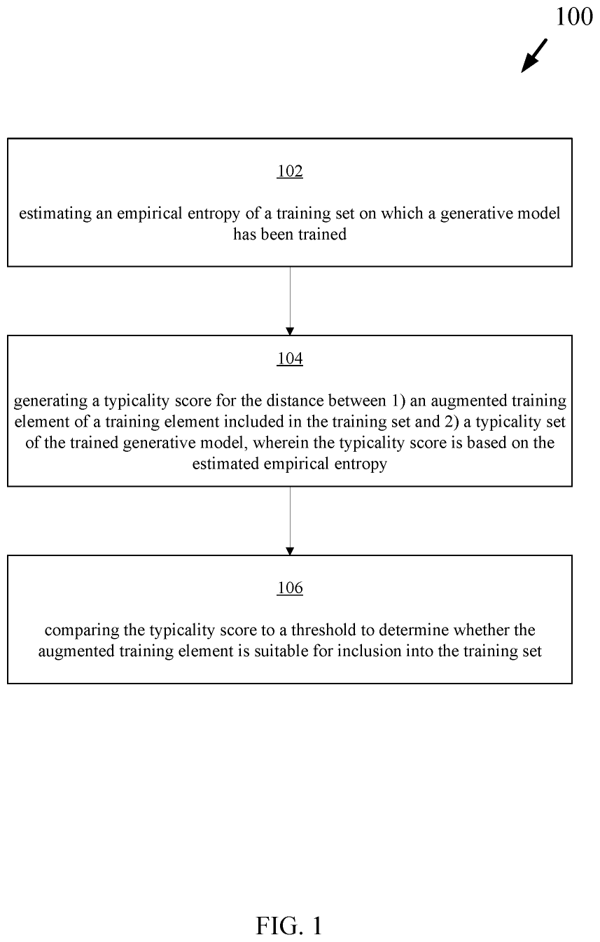

FIG. 1 illustrates a flowchart of an example method 100 in accordance with disclosed embodiments. The method 100 may be used to determine whether an augmented training element is suitable for inclusion in a training set.

At operation 102, the method 100 estimates an empirical entropy of a training set on which a generative model has been trained. Examples of trained generative models that may be used in method 100 include normalizing flows, diffusion models, and variational autoencoders. The estimate of an empirical entropy may be computed over the training set used to train the generative model. In disclosed embodiments, the estimate of the empirical energy Ĥₚ may be computed as described above in relation to Equation (2).

At operation 104, the method 100 generates a typicality score for the distance between 1) an augmented training element of a training element included in the training set and 2) a typicality set of the trained generative model, wherein the typicality score is based on the estimated empirical entropy. In disclosed embodiments, the typicality score may be estimated in as described above in accordance with Equation (2).

At operation 106, the typicality score may be compared to a threshold to determine whether the augmented training element is suitable for inclusion into the training set. In some disclosed embodiments, an augmented sample is determined to be suitable for inclusion when its typicality score is less than or equal to a threshold. In disclosed embodiments, a threshold α may be estimated as described above in accordance with Equation (3).

In disclosed embodiments, each of a plurality of augmented training elements may be evaluated for suitability to be included into a training set. The plurality of augmented training elements may be generated by the same augmentation technique or different augmentation techniques. For example, each of the augmented training elements may be generated by using the same augmentation technique or each of the augmented training elements may be generated by using a different augmentation technique. That is, disclosed embodiments are not limited to particular augmentation techniques.

In disclosed embodiments, a plurality of suitable augmented training elements may be included in an original training set to produce a second training set. The second training set may or may not include all of the training elements in the original training set. That is, one or more of the training elements in the original training set may be removed to produce the second training set. In disclosed embodiments, the second training set may include multiple identical augmented training elements and/or multiple training elements from the original set. This may be done, for example, if particular training elements are meant to be emphasized when training a machine-learning model on the second training set.

One or more machine-learning models may be trained on the second training set. For example, a plurality of machine-learning models may be trained on the second training set. The machine-learning models to be trained may include different machine-learning algorithms. For example, the second training set may be used to train a machine-learning model based on a neural network and also used to train a machine-learning model based on a support vector machine. This may be done, for example, to compare the efficacy of different machine-learning models.

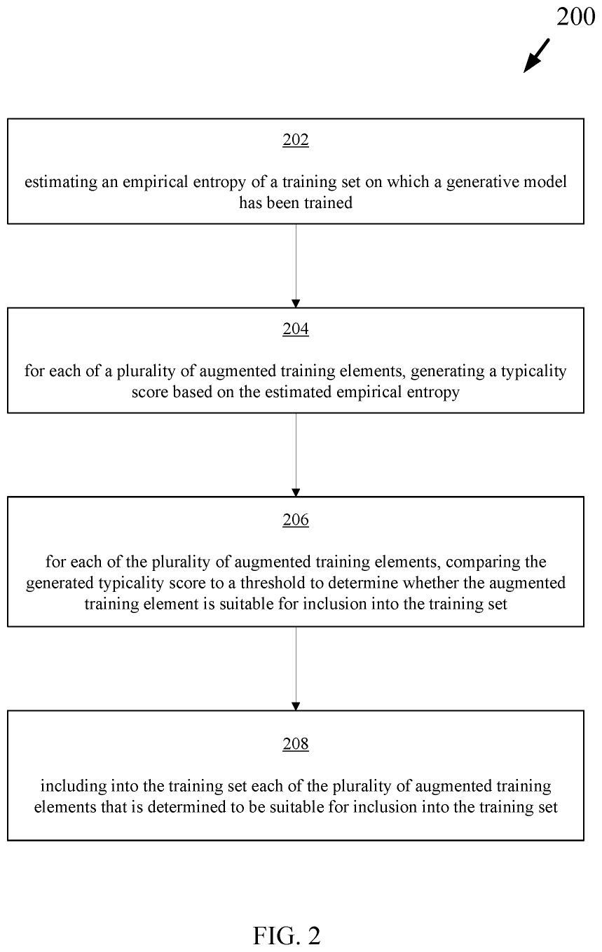

FIG. 2 illustrates a flowchart of an example method 200 in accordance with disclosed embodiments. The method 200 may be used to generate a training set useful for training one or more machine-learning models.

At operation 202, the method 200 estimates an empirical entropy of a training set on which a generative model has been trained. The estimated entropy may be generated in the same matter as described above with respect to operation 102 illustrated in FIG. 1.

At operation 204, the method 200 generates a typicality score for each of a plurality of augmented training sample. In operation 204, the typicality score is based on the estimated empirical entropy. The plurality of augmented training elements may be generated by the same augmentation technique or different augmentation techniques. The typicality scores may be generated in accordance with disclosed embodiments. For example, the typicality scores may be generated in accordance with operation 104 illustrated in FIG. 1.

At operation 206, the method 206 compares the typicality scores generated for each of the plurality of augmented training elements to a threshold to determine whether the augmented training element is suitable for inclusion into the training set. Suitability may be determined in accordance with disclosed embodiments. For example, suitability may be determined in accordance with operation 106 illustrated in FIG. 1.

In operation 208, the method includes into the training set each of the plurality of augmented training elements that is determined to be suitable for inclusion into the training set. In some disclosed embodiments, multiple identical augmented training elements may be included into the training set. In some disclosed embodiments, one or more training elements may be removed from the training set.

The training set including the plurality of augmented training elements may be used to train one or more machine-learning models. For example, a plurality of machine-learning models may be trained on the training set. The machine-learning models to be trained may include different machine-learning algorithms. For example, the second training set may be used to train a machine-learning model based on a neural network and also used to train a machine-learning model based on a support vector machine. This may be done, for example, to compare the efficacy of different machine-learning models.

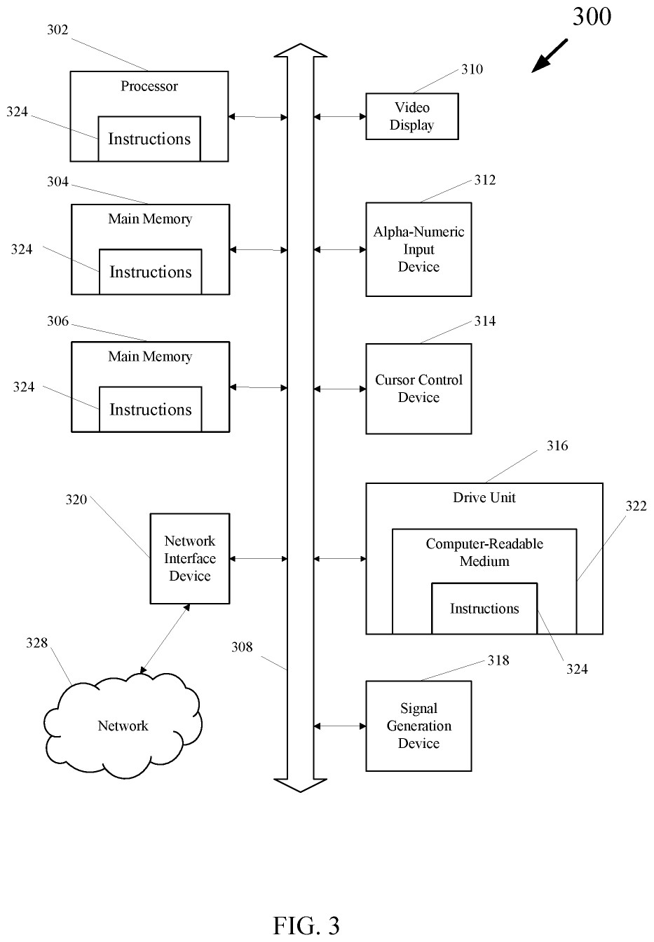

FIG. 3 shows a block diagram of an example embodiment of a general computer system 300. The computer system 300 can include a set of instructions that can be executed to cause the computer system 300 to perform any one or more of the methods or computer-based functions disclosed herein. For example, the computer system 300 may include executable instructions to perform operations disclosed in FIGS. 1 and 2. The computer system 300 may be connected to other computer systems or peripheral devices via a network. Additionally, the computer system 300 may include or be included within other computing devices.

As illustrated in FIG. 3, the computer system 300 may include one or more processors 302. The one or more processors 302 may include, for example, one or more central processing units (CPUs), one or more graphics processing units (GPUs), or both. The computer system 300 may include a main memory 304 and a static memory 306 that can communicate with each other via a bus 308. As shown, the computer system 300 may further include a video display unit 310, such as a liquid crystal display (LCD), a projection television display, a flat panel display, a plasma display, or a solid-state display. Additionally, the computer system 300 may include an input device 312, such as a remote-control device having a wireless keypad, a keyboard, a microphone coupled to a speech recognition engine, a camera such as a video camera or still camera, or a cursor control device 314, such as a mouse device. The computer system 300 may also include a disk drive unit 316, a signal generation device 318, such as a speaker, and a network interface device 320. The network interface 320 may enable the computer system 300 to communicate with other systems via a network 328. For example, the network interface 320 may enable the machine learning system 120 to communicate with a database server (not show) or a controller in manufacturing system (not shown).

In some embodiments, as depicted in FIG. 3, the disk drive unit 316 may include one or more computer-readable media 322 in which one or more sets of instructions 324, e.g., software, may be embedded. For example, the instructions 324 may embody one or more of the methods or functionalities, such as the methods or functionalities disclosed herein. In a particular embodiment, the instructions 324 may reside completely, or at least partially, within the main memory 304, the static memory 306, and/or within the processor 302 during execution by the computer system 300. The main memory 304 and the processor 302 also may include computer-readable media.

In some embodiments, dedicated hardware implementations, such as application specific integrated circuits, programmable logic arrays and other hardware devices, can be constructed to implement one or more of the methods or functionalities described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations, or combinations thereof.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing or encoding a set of instructions for execution by a processor or that cause a computer system to perform any one or more of the methods or functionalities disclosed herein.

In some embodiments, some or all of the computer-readable media will be non-transitory media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method comprising:
estimating an empirical entropy of a training set on which a generative model has been trained;
generating a typicality score for the distance between 1) an augmented training element of a training element included in the training set and 2) a typicality set of the trained generative model, wherein the typicality score is based on the estimated empirical entropy; and
comparing the typicality score to a threshold to determine whether the augmented training element is suitable for inclusion into the training set.

2. The method of claim 1, wherein the trained generative model is a normalizing flow, a diffusion model, or a variational autoencoder.

3. The method of claim 1, wherein the typicality score is an estimate of the distance between the log-density of the trained generative model, wherein x is the augmented training element.

4. The method of claim 1, wherein the typicality score is an estimate according to
$$TS ( x ) = \vert - log p ( x ; θ ) - {\hat{H}}_{p} \vert ,$$
where TS(x) is the typicality score of sample x, p(x; θ) is the density of sample x with respect to the trained generative model having parameters θ, and Ĥₚ is an estimated empirical entropy of the trained generative model.

5. The method of claim 4, wherein the estimated empirical energy Ĥₚ is computed over the training set as
$${\hat{H}}_{p} = {E}_{x ∼ {D}_{t r a i n}} [ - log p ( x ; θ ) ] ,$$
where E_{x˜D}_{ₜᵣₐᵢₙ} is the expected value of the samples x taken from the training set Dₜᵣₐᵢₙ.

6. The method of claim 1, determining the augmented training sample is suitable for inclusion into the training set when the typicality score of the augmented training sample is less than or equal to the threshold.

7. The method of claim 1, wherein the threshold is estimated from samples in the training set as
$$α = {max}_{x ∈ {D}_{t r a i n}} T S ( x ) + ϵ ,$$
where Dₜᵣₐᵢₙ is the training set, x is a sample in the training set, and ϵ is a tunable parameter.

8. The method of claim 1, further comprising:
including the augmented training element into the training set when the augmented training element is determined to be suitable for inclusion into the training set.

9. The method of claim 8, further comprising:
training a machine learning model on the training set including the augmented training element.

10. A non-transitory memory including processor-executable instructions that, when executed by one or more processors, causes a system to perform operations including:
estimating an empirical entropy of a training set on which a generative model has been trained;
generating a typicality score for the distance between 1) an augmented training element of a training element included in the training set and 2) a typicality set of the trained generative model, wherein the typicality score is based on the estimated empirical entropy; and
comparing the typicality score to a threshold to determine whether the augmented training element is suitable for inclusion into the training set.

11. A system comprising:
one or more processors; and
non-transitory memory including processor-executable instructions that, when executed by the one or more processors, causes the system to perform operations including:
estimating an empirical entropy of a training set on which a generative model has been trained;
for each of a plurality of augmented training elements, generating a typicality score based on the estimated empirical entropy;
for each of the plurality of augmented training elements, comparing the generated typicality score to a threshold to determine whether the augmented training element is suitable for inclusion into the training set; and
including into the training set each of the plurality of augmented training elements that is determined to be suitable for inclusion into the training set.

12. The system of claim 11, wherein the estimated empirical energy Ĥₚ is computed over the training set as
$${\hat{H}}_{p} = {E}_{x ∼ {D}_{t r a i n}} [ - log p ( x ; θ ) ] ,$$
where Ĥₚ is the estimated empirical energy and where E_{x˜D}_{ₜᵣₐᵢₙ} is the expected value of the samples x taken from the training set Dₜᵣₐᵢₙ.

13. The system of claim 12, wherein the typicality score is an estimate according to
$$TS ( x ) = \vert - log p ( x ; θ ) - {\hat{H}}_{p} \vert ,$$
where TS(x) is the typicality score of sample x and p(x; θ) is the density of sample x with respect to the trained generative model having parameters θ.

14. The system of claim 11, wherein the threshold is estimated from samples in the training set as
$$α = {max}_{x ∈ {D}_{t r a i n}} T S ( x ) + ϵ ,$$
where Dₜᵣₐᵢₙ is the training set, x is a sample in the training set, and ϵ is a tunable parameter.

15. The system of claim 11, wherein the operations include:
training one or more machine-learning models on the training set after the operation of including augmented training elements is completed.

16. The system of claim 15, wherein the one or more machine-learning models includes a plurality of different machine-learning models.
